(19) United States
(12) Patent Application Publication
(10) Pub. No.: US 2026/0204901 A1
(43) Pub. Date: Jul. 16, 2026

(54) Reduction of Transient Overvoltages in an On-Board Power Supply System

(71) Applicant: Bayerische Motoren Werke Aktiengesellschaft, Muenchen (DE)

(72) Inventor: Florian BIERWIRTH, Steinhoering (DE)

(21) Appl. No.: 19/135,904

(22) PCT Filed: Nov. 27, 2023
(86) PCT No.: PCT/DE2023/100916

§ 371 Date: Jun. 5, 2025

(30) Foreign Application Priority Data
Dec. 16, 2022 (DE) 10 2022 133 579.8

(51) Int. Cl. H02H 9/04; B60L 50/60; B60R 16/033

(52) U.S. Cl. CPC H02H 9/045; B60R 16/033; B60L 50/60

(57) ABSTRACT

A method for reducing transient overvoltages in a current path of an on-board power supply system of a vehicle, the current path carrying a supply voltage and being located between a consumer that generates the overvoltage and a further component, in which method a voltage on the current path is monitored and, if an overvoltage is identified, a previously open short-circuit line between the monitored current path and a reference potential is closed until the overvoltage has been reduced or is likely to be reduced. The present disclosure is advantageously applicable to partly or fully autonomous vehicles, in particular electric vehicles.

### BACKGROUND AND SUMMARY

The present disclosure relates to a method for reducing, in particular, transient overvoltages in a current path of an on-board power supply system of a vehicle, wherein a voltage on the current path is monitored and, in the event that an overvoltage is identified, a previously open short-circuit line between the monitored current path and a reference potential is closed, until the overvoltage has been reduced or is likely to be reduced. The present disclosure also relates to a vehicle having an on-board power supply system which at least comprises a current path which carries a supply voltage, and a voltage measuring device for measuring a voltage on the current path. The present disclosure is particularly advantageously applicable to partially or fully autonomously operated vehicles, in particular to electric vehicles.

DE 10 2014 209 267 A1 discloses a heating apparatus and a method for reducing an overvoltage in a first part of an on-board power supply system of an electrically drivable means of transport. The method comprises the following steps: detection of the overvoltage, or of another element of information which is indicative of an impending overvoltage event, in a first part of the on-board power supply system and, in response thereto, the closing of an electrical connection between an electrical heating apparatus of the means of transport and the first part of the on-board power supply system, in order to reduce the overvoltage.

DE 197 42 391 C1 discloses a method for the protection of electronic control devices in a motor vehicle, wherein overvoltage pulses, in particular load dump pulses, are captured and, in the event of the occurrence of such overvoltage pulses, one or more loads are switched on. As a result, the overvoltage pulse can be reduced very rapidly, even prior to the achievement of the maximum value thereof, in the absence of compensation, such that electronic circuits and control devices contained in the motor vehicle are protected. Overvoltage protection can thus be achieved without the necessity for additional components.

DE 102 91 613 T5 discloses a system for the elimination of an overvoltage in the power supply of a vehicle, which system comprises the following: a load take-up apparatus, having low resistance and high power consumption characteristics; and a control section, which selectively couples the load take-up apparatus to the power supply system, in the event that a voltage of the power supply exceeds a predetermined threshold.

An object of the present disclosure is to at least partially surmount the disadvantages of the prior art and, in particular, the provision of a particularly simple option, which can be implemented in a cost-effective manner, for the reliable reduction of transient overvoltages generated by the recovery of energy from loads in the on-board power supply system.

This object is fulfilled by the features disclosed herein. Preferred embodiments, in particular, can also be inferred from the present disclosure.

This object is fulfilled by a method for reducing, in particular, transient overvoltages in a current path of an on-board power supply system of a vehicle which carries a supply voltage, between a load which generates the overvoltage and a further component, wherein:
a voltage on the current path is monitored and, in the event that an overvoltage is identified:
a previously open short-circuit line between the monitored current path and a reference potential is closed, until the overvoltage has reduced, or is likely to be reduced.

Advantageously, the overvoltage is detectable in a simple manner, and can be reliably reduced by the short-circuit line, if the latter is closed. Moreover, the method can be implemented in a cost-effective manner. Furthermore, complex and time-consuming evaluations can be omitted, such that the short-circuit current flowing in the short-circuit line can be rapidly tripped. Moreover, the short-circuit line can advantageously be employed at a practically arbitrary location, with little or no adaptations of the on-board power supply system.

In particular, transient overvoltages can be generated by a recovery of electrical energy from a load in the current path. This is particularly disadvantageous if further components which are connected to the load via the current path are overvoltage-sensitive, and thus respond to overvoltages in a sensitive manner, e.g. by the generation of malfunctions, outages and/or latent component damage.

The vehicle can be a motor vehicle (e.g. an automobile, such as a passenger car, a heavy goods vehicle, a bus, etc., or a motorcycle), a rail vehicle, a watercraft (e.g. a boat or a ship), or an aircraft (e.g. an airplane or a helicopter). The vehicle can comprise a combustion engine, and/or can comprise a drive battery (“electric vehicle”). The electric vehicle can be, for example, a plug-in hybrid vehicle (PHEV), or a fully electrically powered vehicle, e.g. a battery electric vehicle (BEV).

The on-board power supply system can assume a uniform on-board voltage, or can comprise two or more on-voltage power supply subsystems having a different on-board voltage, e.g. 12 V and 400 V.

According to a further development, the vehicle is a partially or fully autonomously operated vehicle.

In particular, a short-circuit line is understood as an electrical connection between the monitored current path and a reference potential. In particular, no electrical load is incorporated in the short-circuit line. If the short-circuit line is open or non-conducting, this signifies that, in this state, no current (“short-circuit current”) can flow from the current path via the short-circuit line to the reference potential. If the short-circuit line is closed or in a conducting state, this signifies that, in this state, a high “provoked” short-circuit current can flow from the current path via the short-circuit line to the reference potential.

According to one configuration, the short-circuit line is re-opened in the event of a measurement to the effect that the overvoltage has been reduced. This corresponds to the circumstance in which, advantageously, the short-circuit line has been closed or switched to a conducting state until such time as the overvoltage has actually been reduced, which reduction can be established e.g. by a voltage measurement.

According to one configuration, the short-circuit line is re-opened further to the expiry of a stipulated time interval. This corresponds to the circumstance in which the short-circuit line is closed until such time as the reduction of the overvoltage is anticipated. To this end, the time interval is advantageously calibrated such that it at least approximately corresponds to the duration of a typical transient voltage pulse for a load of the relevant type. By this configuration, an advantage is achieved in that, for the termination of the short-circuit current, no measurement is required, and a particularly simple and rapid implementation is thus enabled. Instead, e.g. a simple timer or a corresponding timer function can be employed.

This object is also fulfilled by a vehicle having an on-board power supply system, which is designed to execute the above-mentioned method. The vehicle can be configured in an analogous manner to the method, and vice versa, and assumes the same advantages.

According to one configuration, the vehicle comprises at least the following:
a load and a further component which is connected to the load via a current path which carries the supply voltage;
a voltage measuring device for measuring a voltage on the current path;
a short-circuit line which is interposed between the current path and a reference potential, having a switch and a current limiter which is connected in series thereto; and
a switching device, which is configured to maintain the switch in an open or non-conducting state if the voltage measured by the voltage measuring device still lies below a stipulated first threshold value, to close the switch, or execute the switching thereof to a conducting state, if the measured voltage achieves or overshoots the first threshold value, and to re-open the switch if the measured voltage achieves or undershoots a stipulated second threshold value.

In particular, the reference potential corresponds to a vehicle bodywork or a conductor rail.

The voltage measuring device can also be described as a “voltage sensor”. In particular, the voltage measuring device is arranged between the current path which is to be monitored and the switch. In a particularly simple implementation, the voltage measuring device is configured as an overvoltage sensor, which only generates an output signal or executes a switchover in the event that the measured voltage achieves or overshoots a threshold value which is indicative of an overvoltage. The overvoltage sensor can be, for example, a comparator circuit, incorporating an up-circuit voltage divider, or can comprise a circuit of this type.

The switch, in particular, is an electronic switch, in particular a semiconductor switch, and specifically a power semiconductor switch. According to a further development, the switch is a transistor, e.g. a field-effect transistor, for example a MOSFET. The switch is switched by the switching device and, to this end, is connected to the switching device, in particular by at least one signal line, in particular a data line.

The current limiter limits the short-circuit current flowing in the closed short-circuit line, and thus protects the short-circuit line, including power conductors and associated components, against damage, or even destruction. The current limiter can also be designed to vary the electric current flowing therein. This is particularly advantageous for the prevention of any significant impact of the short-circuit upon the on-board power supply system. This variation can be selected, e.g. according to the connection and the system status. The current limiter can be, for example, an ohmic resistor or a transistor circuit.

The switching device is connected to the voltage measuring device by a signal line, in particular a data line, and is particularly designed to compare measurement signals or data communicated by the voltage measuring device with the first and, optionally, with the second threshold value, and to correspondingly actuate the switch, according to the outcome of this comparison.

The first threshold value and the second threshold value can be identical or different. If the second threshold value is different, in particular, it can be lower than the first threshold value.

According to a further development, the further component comprises a (protective) circuit-breaker, which isolates the further component from the on-board power supply system in the event that an overvoltage is identified on the further component. However, tripping can be disadvantageous if the breaker features a time lag, as a result which the interruption of the current infeed to the load would thus be prolonged. A disadvantage can moreover occur, in the event that other loads are connected to the further component, and would thus be compromised by the tripping of the circuit-breaker. According to one configuration, the targeted tripping of the short-circuit by the short-circuit line occurs more rapidly than the tripping of the circuit-breaker of the further component, such that the tripping of the circuit-breaker can be prevented in a particularly reliable manner. This can also be described to the effect that the further component comprises an overvoltage circuit-breaker, which is tripped in the event of the presence of an overvoltage on the current path, and the short-circuit line is designed, in the event of the identification of an overvoltage on the current path, to close more rapidly or earlier than the tripping of the overvoltage circuit-breaker.

According to a further development, the time to the triggering of the short-circuit by the short-circuit line is shorter than the fault tolerance time interval of the further component or of endangered elements of the further component and/or of the load, or of endangered elements of the load. In particular, the fault tolerance time interval is understood as that time interval within which the component can “withstand” an overcurrent without sustaining damage.

The further component can be, for example, a DC voltage converter, a control device, a “partner system” (steering system, brake, light, wiper, crash module, etc.) or a component provided for partially or fully autonomous driving.

According to one configuration, the further component is an electrical energy store, in particular a battery, e.g. a lithium-ion battery, but also, optionally, a capacitor, e.g. a supercapacitor, etc. In many cases, a battery, according to the dictates of the size and/or cell properties thereof, cannot take up re-injected currents, or can only execute a short-term take-up thereof. The battery can comprise a (protective) battery circuit-breaker.

According to one configuration, the current path connects a positive pole of the electrical energy store to a supply input of the load.

According to one configuration, the load is an electrical braking system, an electric front axle steering system or an electric rear axle steering system, a DC voltage converter, a wiper or a fan. Components of this type are safety-related and, in many cases, have a tendency to generate return currents.

According to one configuration, the short-circuit line additionally comprises a fuse element. Advantageously, the fuse element prevents any damage to the short-circuit line in a particularly reliable manner, e.g. in the event of particularly high and/or prolonged transients, or in the event of a malfunction. According to a further development, the fuse element is, or comprises, an electronic fuse (also described as an “eFuse”).

According to a further development, the short-circuit line comprises a further or second voltage measuring device, which is arranged between the switch and the reference potential. The further voltage measuring device measures the voltage on the reference potential-side terminal of the switch. Thus, according to this further development, two voltage measuring devices are provided, up-circuit and down-circuit of the switch. This provides the advantage of redundancy, and an option for the evaluation of the switch state, e.g. for the validation of a successful switching of the electronic switch and, additionally, outside the context of overvoltage reduction, e.g. for the execution of a functional check.

According to one configuration, the short-circuit line is embodied as a short-circuit module, the first terminal of which is connected to the monitored current path, and the second terminal of which is connected to the reference potential. A module can be installed and connected to the on-board power supply system in a particularly simple manner.

According to one configuration, the switching device and/or the voltage measuring device is a component of the short-circuit module. This enables a particularly simple and compact layout. However, module components, e.g. the voltage measuring device, the further voltage measuring device, the fuse element and/or the switching device, including the switch and the current limiter, can also be arranged externally to the module.

The above-mentioned properties, features and advantages of the present disclosure, and the manner in which these are achieved, are further explained and clarified in conjunction with the following schematic description of one exemplary embodiment, which is described in greater detail with reference to the drawings.

### BRIEF DESCRIPTION OF THE DRAWING

FIG. 1 shows a sketch of a vehicle in accordance with various embodiments.

### DETAILED DESCRIPTION OF THE DRAWING

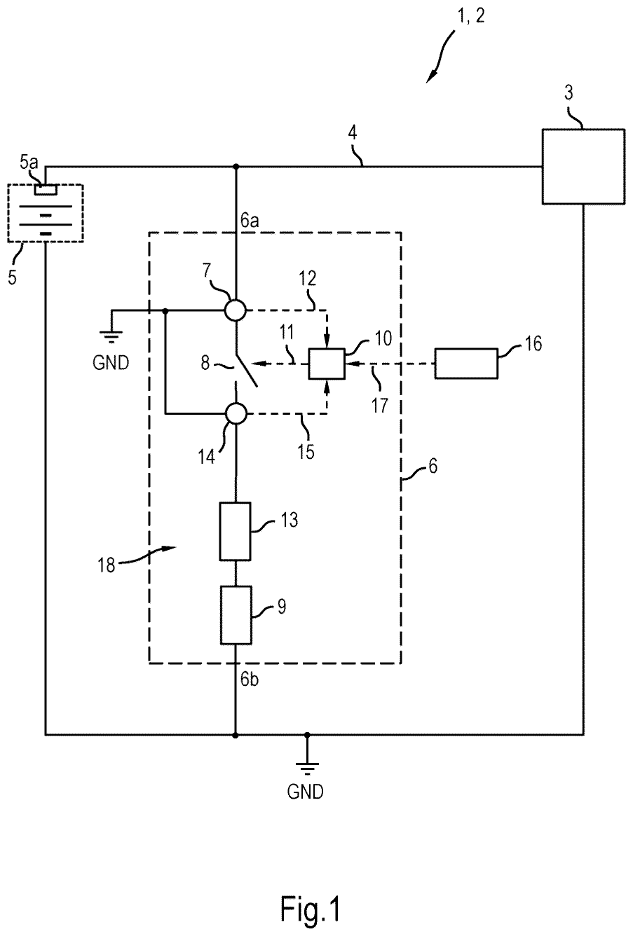

FIG. 1 shows a sketch of a vehicle I having an on-board power supply system 2, on which at least one load 3 can be supplied with electrical energy, and is thus operable. To this end, in the present case, a supply input of the load is connected via a current path 4 to a positive pole of a further component of the on-board power supply system 2 in the form of an electrical energy store 5, e.g. a battery, in particular a lithium-ion battery. The current path 4 thus carries the supply voltage for the load 3. The load 3 and a negative pole of the energy store 5 are connected, on the other side, to a reference potential or ground GND, e.g. to the vehicle bodywork.

The current path 4 and the ground GND are electrically connectable, in a controlled manner, by a short-circuit line 18. To this end, between the current path 4 and ground GND, a short-circuit module 6 is arranged, the first terminal 6a of which is connected to the current path 4 and the second terminal 6b of which is connected to ground. Between the terminals 6a and 6b, a voltage measuring device 7 for measuring a voltage which is present on the current path 4, an electronic switch 8, such as e.g. a MOSFET, and a current limiter 9, such as e.g. an ohmic resistor or a transistor circuit, are arranged in series.

The short-circuit module 6 moreover comprises a switching device 10 for switching the switch 8 and, to this end, is connected to the switch 8 by a signal line 11, in particular a data line, via which a switching signal output is delivered to the switch 8, e.g. to a gate terminal of a MOSFET which is employed as a switch.

The switching device 10 is moreover connected by a signal line 12, in particular a data line, to the voltage measuring device 7, and receives measurement signals or measurement data from the voltage measuring device 7 via the same. In the present case, the switching device 10, additionally to a switching function, is also configured as an evaluation device, and can evaluate measurement signals or measurement data received. In particular, the switching device 10 can be configured as a logic module, and can comprise a computer core, a data memory, optionally an A/D converter, etc. Evaluation is executed such that measurement signals or measurement data are compared with a first threshold value. In the event that the voltage measured on the current path 4 lies below the first threshold value, which typically represents a normal zero-fault status, the switching device 10 maintains the switch 8 in an open position, and no current flows through the short-circuit module 6.

In the event of the identification by the switching device 10 of an overvoltage, to the effect that measurement signals or measurement data achieve or exceed the first threshold value, the switch 8 is actuated such that it closes. As a result, a higher current flows through the short-circuit module 6, the magnitude of which is primarily dictated by the current limiter 9. As a result of this current flux, the-in particular, transient-overvoltage is reduced. In the event that, thereafter, top-down measurement signals or measurement data achieve or exceed a stipulated second threshold value, the switch 8 is actuated such that it re-opens, as a result of which the short-circuit current is interrupted. The second threshold value can be equal to the first threshold value, or can differ therefrom, particularly by the assumption of a lower value. The first threshold value and the second threshold value can be calibrated, e.g. by the programing thereof in the switching device 10, such that they are appropriate to the voltage surge withstand of the energy store 5.

Alternatively or additionally, the function of a time switch or timer can be integrated in the switching device 10, such that the latter executes a re-opening of the switch 8 upon the expiry of a stipulated time interval. This time interval can be calibrated, e.g. by the programing thereof in the switching device 10, such that it corresponds to a duration of a typical transient which is generated by the load 3 on the current path 4. In particular, this time interval can be dependent upon the magnitude of the overvoltage.

Optionally, a protective element 13 such as a contactor 13, an electronic fuse or eFuse, etc., can be arranged in series. As a result, advantageously, any damage to the short-circuit module 6 which is associated with the short-circuit current or a malfunction is reliably prevented.

Optionally, on the opposing side of the switch 8 to the voltage measuring device 7, a further voltage measuring device 14 can be provided, which can be connected to the switching device 10 e.g. by a signal line 15, in particular by a data line.

According to a further exemplary embodiment, the short-circuit module 6 comprises no voltage measuring device 7, but a voltage measuring device 16 is arranged externally to the short-circuit module 6, and transmits measurement signals or data to the switching device 10 by a signal line 17, in particular by a data line.

According to one further exemplary embodiment, the switching device 10 is located externally to the short-circuit module 6.

According to one variant, the battery 5 comprises an overvoltage circuit-breaker (“battery circuit-breaker” 5a), which is tripped in the event of the presence of an overvoltage on the current path. The voltage measuring device 7, the switching device 10 and the switch 8 are designed such that the switch 8, in the event of the identification of an overvoltage on the current path 4, closes significantly more rapidly than the tripping of the battery circuit-breaker 5a.

Naturally, the present disclosure is not limited to the exemplary embodiment represented.

In general, the article “a”, “, ”an“, ” etc. can be understood as a singularity or a plurality, particularly within the meaning of “at least one”, or “one or more”, etc., provided that this is not explicitly excluded, e.g. by the expression “exactly one”, etc.

Indication of number can also signify exactly the number indicated, or can incorporate a customary tolerance margin, provided that this is not explicitly excluded.

### LIST OF REFERENCE SYMBOLS

1 Vehicle
2 On-board power supply system
3 Load
4 Current path
5 Energy store
5a Battery circuit-breaker
6 Short-circuit module
6a First terminal
6b Second terminal
7 Voltage measuring device Switch
9 Current limiter
10 Switching device
11 Signal line
12 Signal line
13 Protective element
14 Further voltage measuring device
15 Signal line
16 Voltage measuring device
17 Short-circuit line
GND Reference potential/ground

1-11. (canceled)

12. A method for reducing transient overvoltages in a current path of an on-board power supply system of a vehicle that carries a supply voltage between a load that generates the overvoltage and a further component, the method comprising:
monitoring a voltage on the current path; and
in response to an overvoltage being identified, closing a previously open short-circuit line between the current path and a reference potential until the overvoltage has reduced or is likely to be reduced.

13. The method according to claim 12, comprising:
re-opening the short-circuit line in response to a measurement indicating that the overvoltage has been reduced.

14. The method according to claim 12, comprising:
re-opening the short-circuit line further to expiry of a stipulated time interval.

15. A vehicle, comprising:
an on-board power supply system, comprising:
a load;
a further component connected to the load via a current path that carries a supply voltage;
a voltage measuring device configured to measure a voltage on the current path;
a short-circuit line interposed between the current path and a reference potential, and comprising a switch and a current limiter connected in series thereto; and
switch control circuitry configured to:
maintain the switch in an open state in response to the voltage measured by the voltage measuring device still lying below a stipulated first threshold value;
close the switch in response to the measured voltage achieving or overshooting the first threshold value; and
re-open the switch in response to the measured voltage achieving or undershooting a stipulated second threshold value.

16. The vehicle according to claim 15,
wherein the further component is an electrical energy store.

17. The vehicle according to claim 16,
wherein the current path connects a positive pole of the electrical energy store to a supply input of the load.

18. The vehicle according to claim 15,
wherein the load is an electric braking system, an electric front axle steering system, or an electric rear axle steering system.

19. The vehicle according to claim 15,
wherein the short-circuit line comprises a fuse or an electronic fuse.

20. The vehicle according to claim 15,
wherein the short-circuit line is configured as short-circuit circuitry, a first terminal of which is connected to the current path, and a second terminal of which is connected to the reference potential.

21. The vehicle according to claim 20,
wherein the switch control circuitry and/or the voltage measuring device is a component of the short-circuit circuitry.

22. The vehicle according to claim 15,
wherein the further component comprises an overvoltage circuit-breaker, that is configured to be tripped in response to a presence of an overvoltage on the current path, and
wherein the short-circuit line is configured to, in response to an identification of an overvoltage on the current path, close more rapidly than the tripping of the overvoltage circuit-breaker.
